(19) United States
(12) Patent Application Publication
(10) Pub. No.: US 2006/0139940 A1
(43) Pub. Date: Jun. 29, 2006

(54) Motor vehicle headlamp unit including a structural portion

(76) Inventor: Arnold Fayt, Jujurieux (FR)

Correspondence Address: EPSTEIN DRANGEL BAZERMAN & JAMES, LLP, 60 EAST 42ND STREET, SUITE 820, NEW YORK, NY, 10165, US

(21) Appl. No.: 11/317,526

(22) Filed: Dec. 23, 2005

(30) Foreign Application Priority Data
Dec. 24, 2004 (FR) 0413928

(51) Int. Cl. B60Q 1/04

(52) U.S. Cl. 362/507; 362/549; 362/390

(57) ABSTRACT

The invention relates to a motor vehicle headlamp unit comprising: a headlamp unit casing comprising a structural portion provided with fastener means for fastening to the end of a crosspiece that is part of the structure of the vehicle, the structural portion being fastened so that it extends the crosspiece outwards and being strong enough to carry the headlamp unit casing while the vehicle is being used; a headlamp glass provided with fastener means for fastening to a geometrical module which is designed to support visible elements at the front of the vehicle; and a link between the headlamp unit casing and the glass, said link being strong enough for the glass, as fastened to the geometrical module, to support the headlamp unit casing so long as said headlamp unit casing is not yet mounted on the structure of the vehicle.

### TECHNICAL FIELD

The present invention relates to motor vehicle bodywork front units.

### STATE OF THE ART

In Document EP 1 352 811, the Applicant has already described a motor vehicle front unit structure subdivided into two modules, namely a structural module including, in particular, a top crosspiece extending over the entire width of the vehicle and supporting various functional members, and secondly a geometrical module supporting the visible elements of the front of the motor vehicle, such as bodywork parts and headlamp units.

One of the advantages of such subdivision is that all of the visible elements of the front of the vehicle form a one-piece assembly which can be mounted on the vehicle as one unit and in which the clearances and alignments are pre-set, independently of the geometrical defects of the structure of the vehicle.

### PROBLEM POSED BY THE STATE OF THE ART

The presence at the front of the vehicle of headlight units and of the top crosspiece of the structural module poses compactness problems because headlamp units are tending to become increasingly voluminous and the space available, in particular in the longitudinal (X) direction and in the vertical (Z) direction is decreasing to a corresponding extent.

A need thus exists for a solution in which the assembly formed by the headlamp unit and by the top crosspiece is of smaller size, but in which the headlamp unit casing can still be positioned so that its glass remains correctly in register relative to the surrounding bodywork parts, in particular those carried by the geometrical module.

### SOLUTION PROPOSED BY THE INVENTION

The invention proposes a solution which solves the above-stated problem and in which the headlamp unit casing still makes it possible for the clearances and alignments between the various visible elements of the front of the vehicle to be managed well.

The present invention provides a motor vehicle headlamp unit comprising:

a headlamp unit casing comprising a structural portion provided with fastener means for fastening to the end of a crosspiece that is part of the structure of the vehicle, the structural portion being fastened so that it extends the crosspiece outwards and being strong enough to carry the headlamp unit casing while the vehicle is being used;

a headlamp glass provided with fastener means for fastening to a geometrical module which is designed to support visible elements at the front of the vehicle; and

a link between the headlamp unit casing and the glass, said link being strong enough for the glass, as fastened to the geometrical module, to support the headlamp unit casing so long as said headlamp unit casing is not yet mounted on the structure of the vehicle.

Thus, by means of the invention, the structural portion of the headlamp unit casing extends the crosspiece of the vehicle, e.g. the top crosspiece of a front end module, so that it is no longer necessary for the structural module of the vehicle to extend over its entire width in order to support the headlamp units. In other words the headlamp units are fastened in a manner such that they are cantilevered out relative to the top crosspiece, and they can be referred to as “self-supporting headlamp units”. The top crosspiece can thus stop at the two headlamp units without extending to the fender supports, unlike in the state of the art.

In a particular embodiment, the link is deformable so that it can deform to accommodate the relative movements that take place between the geometrical module and the headlamp unit casing while the headlamp unit casing is being mounted on the structure of the vehicle, and while the vehicle is being used.

By means of the deformability of the link provided between the headlamp glass and the headlamp casing, it is possible to keep optimized clearances and alignments between the headlamp glass, which is the only visible portion of the headlamp unit, and the surrounding bodywork parts, even after the headlamp unit casing has been fastened to the structure of the vehicle.

Finally, by means of the relative strength of the link between the headlamp glass and the corresponding headlamp casing, the headlamp units are held by the glasses fastened to the geometrical module until said module is mounted on the vehicle. And during this mounting of the front of the vehicle as a single piece, each headlamp unit is fastened via its structural portion to the structure of the vehicle. During this mounting and fastening, the deformable link deforms and it continues to deform while the vehicle is being used, accommodating the relative movements between the geometrical module and the structure of the vehicle (in particular since the headlamp unit casings are self-supporting), but the clearances and alignments between the headlamp glass and the surrounding bodywork pieces are maintained at very small values, obtained by the known subdivision of the front of the vehicle into a geometrical module and a structural module.

In a particular embodiment, the link is weatherproof, and it seals off the casing from the outside of the vehicle.

Another advantage procured by the invention is that it makes it easier to replace the bulbs because, in the state of the art, the presence of the crosspiece behind the headlamp unit obstructs access to the inside thereof. That access is unobstructed in the invention because of the omission of the crosspiece behind the headlamp unit.

In addition, in the vertical direction (Z), it is advantageous to have an increased stroke for accommodating an impact from the head of a pedestrian, in order to improve energy absorption during such an impact. The invention procures this advantage.

Another advantage of the invention is that the omission of the side arms on the front panel makes it possible to imagine mounting from an unusual direction, e.g. by a movement in translation with a small amount of rotation in an upward direction, since the headlamp units are no longer obstructed by the top crosspiece of the front panel.

### PARTICULAR EMBODIMENTS

In various embodiments of the invention that can be taken in isolation or in combination:

the link between the glass and the casing is constituted by a seal of flexible adhesive that accommodates relative movement between the glass and the casing without losing weatherproofing;

the structural portion of the headlamp unit casing is constituted by an array of ribs;

the structural portion of the headlamp unit casing is dimensioned so that two casings and the structure on either side of which said casings are fastened constitute an assembly whose inertia is sufficient for the rigidity of the body of the vehicle to be preserved between its two front fenders; and

the deformable link is provided with holding tabs for holding the glass and the casing together, said tabs being designed to break once the casing is fastened to the structure of the vehicle.

### BRIEF DESCRIPTION OF THE DRAWING

In order to enable the invention to be better understood, an embodiment is described below by way of example not limiting the scope of the invention and with reference to the accompanying drawing, in which:

FIG. 1 is a perspective view of a front end module suitable for receiving a headlamp unit of the invention;

FIG. 2 is a section view through a headlamp unit of the invention and through its environment; and

FIG. 3 is an exploded perspective view of a front made up firstly of two headlamp units and a bumper skin, and secondly of a front end module.

### MORE DETAILED DESCRIPTION

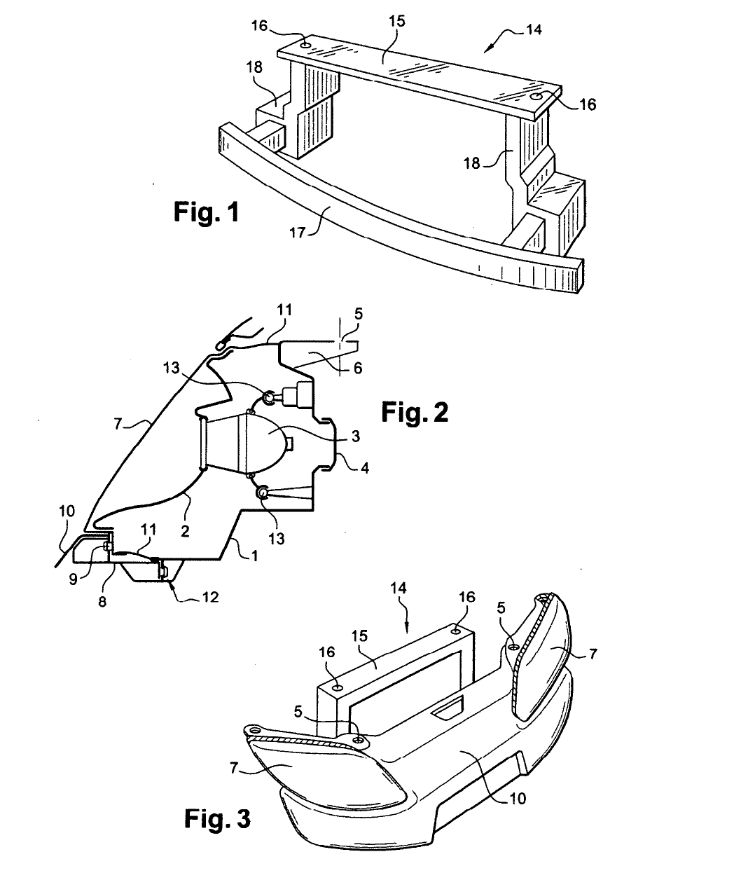

A front unit including a headlamp unit casing of the invention is made up of a structural module, shown in FIG. 1, and of a geometrical module, shown in FIG. 3.

The headlamp unit, shown in FIG. 2, is made up of a casing 1 and of a glass 7. The headlamp unit casing 1 comprises a reflective lining 2, a headlamp 3 and a closure cap 4. The casing 1 is further provided with fastener means for fastening to the structure of the vehicle, which fastener means are constituted by through orifices 5 for receiving screws.

The fastener means 5 are provided on a structural portion of the casing that is made up of an array of reinforcing ribs 6. The array of ribs 6 extends along the top edge of the casing. It is dimensioned so that, if two casings are mounted on a front panel, on either side thereof, an assembly is obtained whose inertia is sufficient so that the rigidity of the body of the vehicle, between its two front fenders is preserved, i.e. the inertia is the same as if the front end module had arms extending to the fenders. The glass 7 of the headlamp unit is provided with fastener means for fastening to the geometrical module of the vehicle.

The geometrical module is made up of bodywork elements that are visible at the front of the vehicle, namely a bumper skin 10, and of a frame 8 supporting the skin 10 and the headlamp glasses 7. The fastener means for fastening each glass to the geometrical module, and more precisely to the frame 8, are made up of a plurality of snap-fastener fingers for fastening the glass to the frame, which fingers are integrally molded with the glass. The fastener means for fastening the skin to the frame are not shown.

Finally, the headlamp unit is provided with a link between the casing 1 and the glass 7 that is strong enough to enable the glass 7, as fastened to the frame 8, to support the casing 1 so long as it is not yet mounted on the structure of the vehicle. Said link comprises an elastomer sleeve 11, a fastener point 12 for fastening with clearance between the glass 7 and casing 1, and a ball 13 making it possible to adjust the angular positioning of the headlamp. The sleeve can be in the form of bellows or be constituted by a bead of adhesive or by a flexible gasket. This link is weatherproof and deformable so as to accommodate the relative movements that take place between the geometrical module 8 and the casing 1 while the casing is being mounted on the structural module 14 of the vehicle and while the vehicle is being used.

The fastener point 12 for fastening with clearance reinforces the temporary link between the glass and the casing so long as the casing is not fastened to the structure. But said clearance is sufficient both to allow the glass to be positioned correctly relative to the casing and also to accommodate the relative movements that take place between the casing and the frame (and thus the bumper) while the vehicle is being used (vibration during motoring, exposure to sun/heating, fatigue, etc.).

The structural module of the vehicle is made up of a front end module 14 that comprises a top crosspiece 15, two fastener points 16 for fastening the casing 1 to the crosspiece 15, and a Danner impact crosspiece. The Danner crosspiece extends from one upright to the other while bearing (indirectly) on the side rails (not shown) of the vehicle.

A screw (not shown) passes through the through orifice 5 and penetrates into the fastener point 16 provided on the crosspiece 15. It fastens the casing to the structure of the vehicle while the front made up of the frame, of the bumper skin, and of the headlamp units is being mounted onto the vehicle.

As can be observed, the front panel is more compact than usual because it does not have side arms for supporting the headlamp units. The width of the front panel is thus substantially equal to the distance between the two side rails (not shown) of the vehicle.

Naturally, the above-described embodiment is in no way limiting and can undergo any desirable modifications without going beyond the ambit of the invention.

What is claimed is:

1. A motor vehicle headlamp unit comprising:
a headlamp unit casing comprising a structural portion provided with fastener means for fastening to the end of a crosspiece that is part of the structure of the vehicle, the structural portion being fastened so that it extends the crosspiece outwards and being strong enough to carry the headlamp unit casing while the vehicle is being used;
a headlamp glass provided with fastener means for fastening to a geometrical module which is designed to support visible elements at the front of the vehicle; and
a link between the headlamp unit casing and the glass, said link being strong enough for the glass, as fastened to the geometrical module, to support the headlamp unit casing so long as said headlamp unit casing is not yet mounted on the structure of the vehicle.

2. A headlamp unit according to claim 1, in which the link is deformable, so that it can deform to accommodate the relative movements that take place between the geometrical module and the headlamp unit casing while the headlamp unit casing is being mounted on the structure of the vehicle, and while the vehicle is being used.

3. A headlamp unit according to claim 1, in which the link is weatherproof.

4. A headlamp unit according to claim 3, in which the link between the glass and the casing is constituted by a seal of flexible adhesive.

5. A headlamp unit according to claim 1, in which the structural portion is constituted by an array of ribs.

6. A headlamp unit according to claim 1, in which the structural portion of the headlamp unit casing is dimensioned so that two casings and the structure on either side of which said casings are fastened constitute an assembly whose inertia is sufficient for the rigidity of the body of the vehicle to be preserved between its two front fenders.

7. A headlamp unit according to claim 1, in which the deformable link is provided with holding tabs for holding the glass and the casing together, said tabs being designed to break once the casing is fastened to the structure of the vehicle.

8. A headlamp unit according to claim 1, in which the structural portion of the casing is arranged to be cantilevered out relative to the crosspiece that is part of the structure of the vehicle.
